(19) United States
(12) Patent Application Publication
(10) Pub. No.: US 2026/0016689 A1
(43) Pub. Date: Jan. 15, 2026

(54) VEHICLE WINDOW GLASS AND VEHICLE-MOUNTED PROJECTION SYSTEM

(71) Applicant: SAINT-GOBAIN GLASS FRANCE, COURBEVOIE (FR)

(72) Inventors: Yiheng ZHANG, SHANGHAI (CN); Lu WANG, SHANGHAI (CN); Ce SHI, SHANGHAI (CN); Daming LI, SHANGHAI (CN); Chong ZHOU, SHANGHAI (CN)

(21) Appl. No.: 18/994,973

(22) PCT Filed: Aug. 9, 2023
(86) PCT No.: PCT/CN2023/111913

§ 371 Date: Jan. 15, 2025

(30) Foreign Application Priority Data
Aug. 11, 2022 (CN) 202210960647.3

(51) Int. Cl. G02B 27/01; B32B 17/10; G02F 1/1334; G02F 1/137; G02F 1/157

(52) U.S. Cl. CPC G02B 27/0101; B32B 17/10036; B32B 17/10504; G02F 1/1334; B32B 2250/05; B32B 2305/55; B32B 2605/00; G02B 2027/0118; G02B 2027/0194; G02F 1/13725; G02F 1/157

(57) ABSTRACT

A vehicle window glass is suitable for cooperating with a projection device to provide a projection function. The vehicle window glass includes a first glass body, a second glass body, an imaging layer and a dimming film sandwiched between the first glass body and the second glass body, wherein an image projected by the projection device on one side of the vehicle window glass displays the projected image on the other side via the vehicle window glass, and the dimming film is configured to be capable of adjusting light transmittance and/or haze to enhance the projection effect of the imaging layer and/or provide privacy effect.

### FIELD

The present disclosure relates to the technical field of vehicles, in particular to a vehicle window glass having projection function and a vehicle-mounted projection system realized by combining a projection device with the vehicle window glass having projection function.

### BACKGROUND

With the rapid development of automobile industry, vehicle-mounted multimedia technology has been widely valued by vehicle manufacturers and favored by consumers. At present, the common vehicle-mounted projection systems in the market are mostly applied to the rear windshield of taxis to project advertising content to the outside of the vehicle. For external projection, vehicle manufacturers and users constantly put forward higher requirements and hope to adjust or improve the occasion of projecting image, image quality, image content privacy, vehicle internal privacy and other aspects according to different requirements.

### SUMMARY

The purpose of the present disclosure is to improve the existing vehicle-mounted projection mode and hope to provide information images in a diversified way through a vehicle window glass, and propose a vehicle window glass and a vehicle-mounted projection system, which can switchably display any supported information to the interior and/or exterior of the vehicle for different applications and user requirements through an imaging layer or projection display layer and a switchable dimming film layer integrated in the vehicle window glass.

Therefore, according to one aspect of the present disclosure, a vehicle window glass is provided. The vehicle window glass is suitable for cooperating with a projection device to provide a projection function. The vehicle window glass comprises a first glass body, a second glass body, and an imaging layer and a dimming film sandwiched between the first glass body and the second glass body, wherein an image projected by the projection device on one side of the vehicle window glass displays the projected image on the other side via the vehicle window glass, and the dimming film is configured to be capable of adjusting light transmittance and/or haze to enhance the projection effect of the imaging layer and/or provide privacy effect.

According to the above technical concept, the embodiment of the present disclosure may further include any one or more of the following alternative forms.

In some alternative forms, the vehicle window glass further comprises a first intermediate layer for attaching the dimming film to the first glass body, and the imaging layer is attached to the second glass body directly or through a second intermediate layer.

In some alternative forms, the imaging layer is directly attached to the second glass body by back adhesive or coating.

In some alternative forms, the imaging layer is directly attached to the dimming film or attached to the dimming film through a third intermediate layer.

In some alternative forms, the imaging layer is directly attached to the dimming film by coating.

In some alternative forms, the imaging layer is formed as a portion of the dimming film.

In some alternative forms, the imaging layer is formed as a portion of the second intermediate layer.

In some alternative forms, the imaging layer is formed as a portion of the second intermediate layer by being coated on or fused with the second intermediate layer.

In some alternative forms, the imaging layer is formed as a portion of the third intermediate layer.

In some alternative forms, the imaging layer is formed as a portion of the third intermediate layer by be coated on or fused with the third intermediate layer.

In some alternative forms, the imaging layer is configured as a back projection imaging layer of any one of film layer, coating layer and micro-structure layer.

In some alternative forms, the dimming film is configured as any one of polymer dispersed liquid crystal, polymer network liquid crystal, guest-host liquid crystal and electrochromic.

In some alternative forms, the dimming film is configured as polymer dispersed liquid crystal, and the imaging layer is closer to or farther from the projection device than the dimming film.

According to another aspect of the present disclosure, a vehicle-mounted projection system is provided. The vehicle-mounted projection system comprises a projection device, a human-machine interaction unit and the above-mentioned vehicle window glass.

In some alternative forms, the projection device is arranged inside or outside the vehicle so as to project image to outside or inside the vehicle.

The vehicle-mounted projection system disclosed by the present disclosure integrates a vehicle window glass having an imaging layer and a dimming film with a projection device, and can provide various supported information to the interior and/or exterior of the vehicle without affecting the performance and aesthetics of the vehicle window glass itself. Through the different optimized designs of the imaging layer and/or the dimming film, diversified display modes are provided to meet the different requirements of users and improve the user experience.

### BRIEF DESCRIPTION OF THE DRAWINGS

Other features and advantages of the present disclosure will be better understood by the following alternative embodiments described in detail in conjunction with the accompanying drawings, in which the same reference numerals identify the same or similar parts, in the drawings:

FIG. 1 is a schematic sectional view of a vehicle window glass according to a first embodiment of the present disclosure;

FIG. 2 is a schematic sectional view of a vehicle window glass according to a second embodiment of the present disclosure;

FIG. 3 is a schematic sectional view of a vehicle window glass according to a third embodiment of the present disclosure;

FIG. 4 is a schematic sectional view of a vehicle window glass according to a fourth embodiment of the present disclosure;

FIG. 5 is a schematic sectional view of a vehicle window glass according to a fifth embodiment of the present disclosure.

### DETAILED DESCRIPTION OF EMBODIMENTS

The implementation and use of the embodiments are discussed in detail below. However, it should be understood that the specific embodiments discussed merely exemplify the specific ways of implementing and using the present disclosure, and do not limit the scope of the disclosure. When describing the structural positions of various components, such as the directions of upper, lower, top, bottom, etc., the description is not absolute, but relative. When the various components are arranged as shown in the figures, these directional expressions are appropriate, but when the positions of the various components in the figures would be changed, these directional expressions would also be changed accordingly.

In this context, the expression “comprising” or similar expressions “including”, “containing” and “having” which are synonymous are open, and do not exclude additional unlisted elements, steps or ingredients. The expression “consisting of . . . ” excludes any element, step or ingredient that is not specified. The expression “consisting essentially of . . . ” means that the scope is limited to the specified elements, steps or ingredients, plus the optional elements, steps or ingredients that do not materially affect the basic and new features of the claimed subject matter. It should be understood that the expression “comprising” covers the expressions “consisting essentially of” and “consisting of”.

In this context, the terms “first”, “second” and so on are not used to limit the sequence and the number of components unless otherwise stated.

In this context, unless otherwise specified, the terms such as “installation”, “connection” and “attach” should be understood broadly. For example, it can be fixed connection, detachable connection or integrated; it can be directly connected or indirectly connected through an intermediate medium, and it can be the internal communication of two components or the interaction between two components. For those skilled in the art, the specific meanings of the above terms in this context can be understood according to specific situations.

In this context, “outside” and “inside” are relative to the direction of vehicle body, “outside” refers to the direction away from the vehicle body, and “inside” refers to the direction facing the vehicle body. “Front” and “rear” are relative to the direction of vehicle travel, “front” refers to the direction toward the direction of vehicle travel, and “rear” refers to the direction away from the direction of vehicle travel.

In this context, “orthographic projection” means that the installation position of the projection device is located on the same side of the vehicle window glass as the observer, and the light emitted by the projection device projects onto the vehicle window glass to form an image, and then the light is reflected to the observer's eyes, also known as reflective projection, which is generally suitable for projecting images to the inside of the vehicle. “Back projection” means that the installation position of the projection device and the observer are located on both sides of the vehicle window glass, and the light emitted by the projection device is projected from one side of the vehicle window glass and enters the eyes of the observer on the other side through the vehicle window glass, also known as transmissive projection, which is generally suitable for projecting images to the outside of the vehicle.

Generally, the projection device is arranged on a component inside the vehicle, and projects an image to the inside or outside of the vehicle through a vehicle window glass having an imaging material. For the way of projecting to the inside of the vehicle (inward projection), because it is transparent projection, portion of the light will inevitably scatter outward, so that people outside the vehicle can also see the projected image. Although the seen image is reversed from the actual image, it will still affect the privacy of users in the vehicle using the vehicle-mounted projection system, resulting in users not being able to project some confidential information at will. Therefore, in the existing designs, the privacy protection of the inward projection image is realized by integrating a privacy film in the vehicle window glass, so that the user can watch any projected image in the vehicle with peace of mind. In addition, because the privacy film is dark film, it can also enhance the brightness of the image displayed by the inward projection. However, for the way of projecting to the outside of the vehicle (outward projection), at present, the vehicle window glass having projection function is widely used on the rear windshield of taxis, for example, to put pictures or video advertisements. It has been realized that the projection film on the rear windshield having projection function is usually attached internally, and its service life is about 1˜2 years, which can not pass the durability standard conditions of vehicle regulations. Moreover, the projection film used in the taxi has low light transmittance, excessive haze, low resolution, low definition and small viewing angle, so it can not meet the requirements of light transmittance and haze required by vehicle door glass if it is used in occasions such as the vehicle door glass. In addition, the projector on the taxi is a post-mounted shelf product, which can not pass the durability standard conditions of vehicle regulations, and can only be controlled by remote control but not communicate with the vehicle device. For manufacturers and most vehicle users or passengers, since the projected image is exposed to the environment and there is no low brightness environment in the vehicle for comparison, the demand for brightness of the projected image will be higher, and it is also hoped that transparent and opaque outward projection can be realized at the same time.

Therefore, according to the concept of the present disclosure, a vehicle window glass is provided, which is suitable for cooperating with a projection device to provide a projection function. The vehicle window glass includes a first glass body, a second glass body, and an imaging layer and a dimming film sandwiched between the first glass body and the second glass body, wherein an image projected by the projection device on one side of the vehicle window glass displays the projected image on the other side via the vehicle window glass, and the dimming film is configured to be capable of adjusting the light transmittance and/or haze to enhance the projection effect of the imaging layer and/or provide privacy effect.

In this context, the projected image is not limited, for example, it can be static text, numbers, symbols or pictures, or it can also be dynamic video.

Hereinafter, it is mainly described that the vehicle window glass is applied to the vehicle door glass of compact vehicle, but it is not excluded that the present disclosure can be applied to other transports such as buses, rail vehicles, airplanes or ships. Also, it should be understood that the vehicle window glass according to the present disclosure includes, but is not limited to, front windshield, rear windshield, skylight glass, vehicle door glass or corner window glass. In the various described embodiments, unless otherwise specified, the thickness of the glass is the thickness commonly used in the art, and the thickness of each laminated structure on the glass is suitable for the conventional range, and is not limited as shown in the figures. In addition, although it is shown as plane glass in the figures, the vehicle window glass of the present disclosure may also be curved glass. In various embodiments, it is described as an independent glass body or a glass plate; however, in some undescribed cases, the surface of the glass can also use special coating to improve other properties such as thermal insulation and/or comfort.

As mentioned above, the vehicle window glass of the present disclosure integrates the imaging layer and the dimming film into the laminated glass at the same time, and provides the image projected by the projection device located at one side of the vehicle window glass to the observer at the other side of the vehicle window glass by means of back projection. Alternatively, the imaging layer is configured as a back projection imaging layer of any one of film layer, coating layer and micro-structure layer. Alternatively, the dimming film is configured as any one of polymer dispersed liquid crystal (PDLC), polymer network liquid crystal (PNLC), guest-host liquid crystal (GHLC) and electrochromic (EC). Through the different combination designs of the dimming film and the imaging layer, the brightness of the projected display image can be enhanced, and the projection function of the vehicle window glass in transparent state or opaque state can be realized by switching as required. Depending on the position of the projection device (inside the vehicle or outside the vehicle), the vehicle window glass of the present disclosure can realize the functions of enhancing the display effect of the inward projection and/or the outward projection and the privacy protection.

It should be understood that “enhance” in this context means that when the dimming film is switched from the transparent state to the opaque state (haze state and/or low light transmittance), the clarity of the image projected by the imaging layer can be significantly improved in the back projection mode, for example, when the projection device is inside the vehicle, the image projected by the imaging layer will be clearer. Different from the existing design, by reasonably selecting materials and optimizing structural design, the switching from the transparent state to the opaque state of the dimming film will not affect the effect of the inward projection. The “privacy” in this context is usually for people inside the vehicle. When the projection device is arranged inside the vehicle for the outward projection, the switching of the dimming film from the transparent state to the opaque state can make people outside the vehicle observe the projected image with enhanced effect but can not see the situation inside the vehicle, thus realizing the privacy protection function. Similarly, when the projection device is arranged outside the vehicle for the inward projection, people outside the vehicle can not see the situation inside the vehicle, while people inside the vehicle can observe the projected image with enhanced effect.

The beneficial effects that can be achieved by various alternative combinations will be more clearly understood from the following description of several exemplary alternative embodiments.

In some embodiments, the vehicle window glass further includes a first intermediate layer for attaching the dimming film to the first glass body, and the imaging layer is attached to the second glass body directly or through a second intermediate layer. In some embodiments, the imaging layer is directly attached to the dimming film or attached to the dimming film through a third intermediate layer.

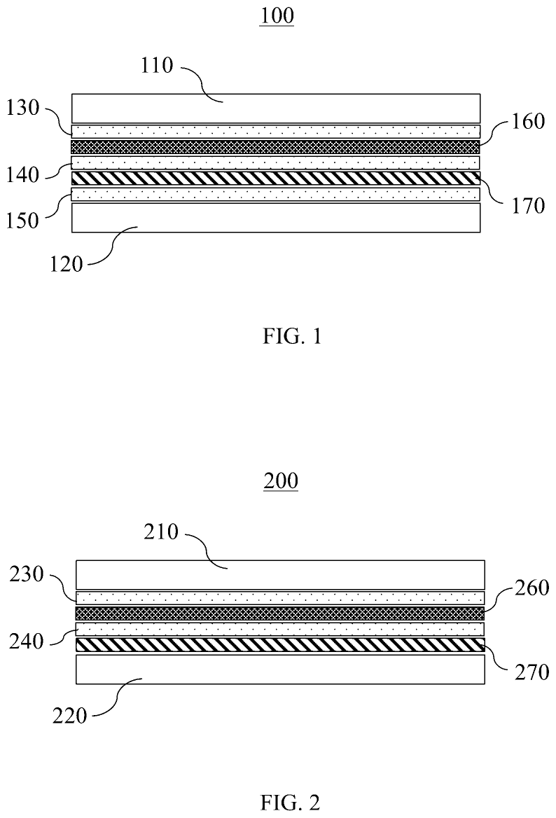

With specific reference to a first embodiment shown in FIG. 1, a vehicle window glass 100 includes a first glass body 110 and a second glass body 120, and a dimming film 160 is attached to the first glass body 110 through a first intermediate layer 130, and an imaging layer 170 is attached to the second glass body 120 through a second intermediate layer 150. In this embodiment, the imaging layer 170 is in the form of a film layer, for example, a back projection film without back adhesive, and the base material can be polyethylene terephthalate (PET), polyvinyl chloride (PVC), thermoplastic elastomer (TPE), polyurethane (PU) and other materials suitable for soft film. Moreover, the imaging layer 170 is attached to the dimming film 160 through a third intermediate layer 140, or in other words, the imaging layer 170 in this embodiment is sandwiched between the second intermediate layer 150 and the third intermediate layer 140. The first intermediate layer 130, the second intermediate layer 150 and the third intermediate layer 140 are adhesive layers suitable for the laminated glass, such as PVB (polyvinyl butyral) or EVA (ethylene-vinyl acetate copolymer). In this way, the first glass body 110, the second glass body 120, the imaging layer 170 and the dimming film 160 are bonded into a whole by each intermediate layer. Compared with the existing projection glass with adhesive film, the sandwich structure integrated in the laminated glass can effectively protect the imaging layer and increase the service life.

As an example, the first glass body 110 and the second glass body 120 can be ordinary white glass, preferably ultra-white glass, and have the thickness range of 0.1 mm˜0.3 mm. The dimming film 160 may be a PDLC dimming film. The imaging layer 170 can be a transparent back projection film without the back adhesive, and have the thickness range of 0.05 mm˜0.3 mm. When each intermediate layer is chosen as PVB or EVA, the thickness can be chosen as 0.38 mm and 0.76 mm. Alternatively, each intermediate layer can be also chosen as other materials such as PET, polymethylmethacrylate (PMMA), or ultra-thin adhesive materials (such as MOVITAL). When non-MOVITAL materials are selected, the thickness range is 0.1˜0.5 mm, while when MOVITAL materials are selected, the thickness range is 0.05 mm˜0.2 mm.

In some embodiments, the first glass body 110 faces the outside of the vehicle, which may be called outer glass, and the second glass body 120 faces the inside of the vehicle, which may be called inner glass. When the projection device is arranged on the interior parts of the vehicle, that is, on the side of the second glass body 120, the imaging layer 170 in the vehicle window glass 100 illustrated in FIG. 1 is closer to the projection device than the dimming film 160. Under this arrangement, in some embodiments, since the PDLC dimming film 160 has haze function itself and is also a good display material for the outward projection or the back projection, when the power supply to the PDLC dimming film 160 is stopped to make it hazed (opaque), both the hazed PDLC film and the transparent back projection film are good outward scattering media, and the image projected by the projection device in the vehicle are intercepted by the imaging layer 170 and the PDLC dimming film 160 at the same time. The enhanced superposition of the image makes the image brighter and clearer, and enhances the brightness of the image displayed by the outward projection, thus enhancing the effect of the outward projection. At the same time, the hazed PDLC film also plays a role in the privacy protection, and the inside of the vehicle cannot be seen from the outside. In this state, the vehicle window glass is suitable for realizing the functions of information interaction with the driver or the passenger before getting on the vehicle, such as welcoming and vehicle inspection and so on. When the PDLC dimming film 160 is powered on, the PDLC film is switched to the transparent state, and the function of transparent outward display can be obtained in this state, which is suitable for scenes where information needs to be displayed and the driver or the passenger needs to observe external conditions when interacting with other vehicles or the pedestrians outside the vehicle.

It should be understood that in some embodiments, the projection device can be arranged outside the vehicle, for example, arranged on vehicle sheet metal or vehicle window frame. At this time, the vehicle window glass can be used to project image to the inside of the vehicle. The inventors found that when the projection device is arranged on the side of the first glass body 110 and the dimming film 160 adopts a PDLC film, the vehicle window glass 100 illustrated in FIG. 1 can also obtain satisfied projection effect, that is, the imaging layer 170 is farther away from the projection device than the dimming film 160.

In a second embodiment illustrated in FIG. 2, similar to FIG. 1, a vehicle window glass 200 includes a first glass body 210 and a second glass body 220, and a dimming film 260 is attached to the first glass body 210 through a first intermediate layer 230, and an imaging layer 170 takes the form of a film layer and is attached to the dimming film 260 through a third intermediate layer 240. The difference is that the imaging layer 270 is directly attached to the second glass body 220.

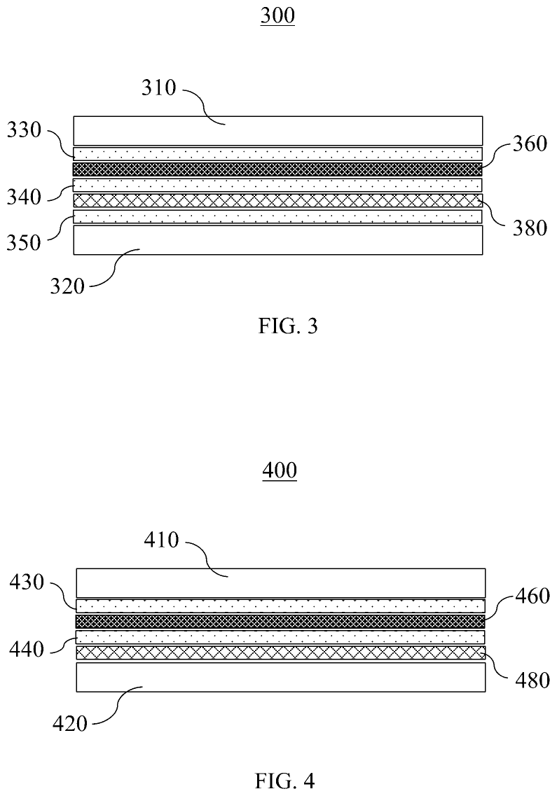

In some embodiments, the imaging layer 270 adopts a back projection film with the back adhesive, so as to be directly attached to the second glass body 220 by adhesion. As the back adhesive increases the thickness of the film layer, the thickness range of the imaging layer is 0.1 mm˜0.5 mm as an example. In some embodiments, like a third embodiment illustrated in FIG. 3, similar to FIG. 1, a vehicle window glass 300 includes a first glass body 310 and a second glass body 320, a dimming film 360 is attached to the first glass body 310 through a first intermediate layer 330, and an imaging layer 380 is attached to the second glass body 320 through a second intermediate layer 350. The difference is that the imaging layer 380 takes the form of a coating and is attached to the dimming film 360 through a third intermediate layer 340. Since the thickness of the coating is smaller than that of the film layer, and it is easier to implement, more feasible combinations can be derived.

As an example, in the embodiment shown in FIG. 3, the imaging layer 380 in the form of a coating may be coated on one of the second intermediate layer 350 and the third intermediate layer 340, in other words, the imaging layer 380 is formed as a portion of the second intermediate layer 350 or the third intermediate layer 340, and then is bonded with the other to form a whole, which sandwiches the imaging layer 380 therebetween. Finally, it is laminated with the dimming film 360, the first glass body 310 and the second glass body 320.

In some embodiments, the imaging layer can be formed as a portion of the intermediate layer by fusing the imaging material to the intermediate layer. For example, the imaging material and the intermediate layer material (such as PVB) are fused and coextruded, thus forming the intermediate layer having imaging function, giving consideration to both imaging and adhesion, and reducing the thickness of the finished product.

A fourth embodiment shown in FIG. 4 is similar to that in FIG. 2. In this embodiment, a vehicle window glass 400 includes a first glass body 410 and a second glass body 420, and a dimming film 460 is attached to the first glass body 410 through a first intermediate layer 430, and an imaging layer 480 is attached to the dimming film 460 through a third intermediate layer 440 and directly attached to the second glass body 420. The difference is that the imaging layer 480 takes the form of a coating.

As an example, the imaging layer 480 in the form of a coating can be coated on the third intermediate layer 440 to form a whole, in other words, the imaging layer is formed as a portion of the third intermediate layer 440, and then laminated with the dimming film 460, the first glass body 410 and the second glass body 420. Alternatively, the imaging layer 480 can be coated on the second glass body 410, and then laminated with the dimming film 460 and the first glass body 410 via the first intermediate layer 430 and the third intermediate layer 440. Similarly, the imaging layer 480 may be formed as a portion of the third intermediate layer in such a way as to be fused to the third intermediate layer 440.

In some embodiments, the imaging layer can be directly coated on the second glass body as a functional coating. For example, as shown in FIG. 4, the imaging layer is coated on the surface of the second glass body 420 facing the first glass body 410, that is, the non-air surface.

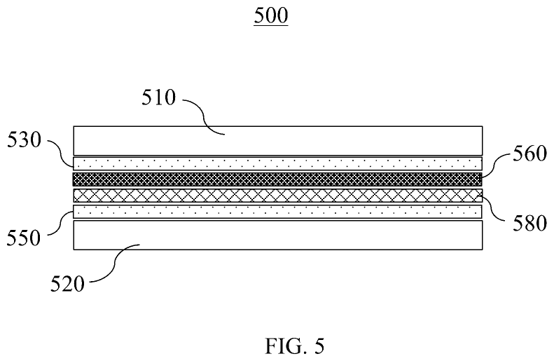

FIG. 5 illustrates a fifth embodiment. In this embodiment, similar to FIG. 3, a vehicle window glass 500 includes a first glass body 510 and a second glass body 520, a dimming film 560 is attached to the first glass body 510 through a first intermediate layer 530, and an imaging layer 580 takes the form of a coating and is attached to the second glass body 520 through a second intermediate layer 550. The difference is that the imaging layer 580 is directly attached to the dimming film 560.

In some embodiments, the imaging layer 580 is directly attached to the dimming film 560 by coating. As an example, the imaging layer 580 is coated on the dimming film 560 to form a whole, in other words, the imaging layer is formed as a portion of the dimming film, and then laminated with the first glass body 510 and the second glass body 520 via the first intermediate layer 530 and the second intermediate layer 550. In this way, the base solution of the imaging layer 580 is advantageously selected as a material that can be adhered to the base material (e.g., PET) of the dimming film (e.g., PDLC). In some embodiments, the imaging layer 580 can also be directly coated on the second intermediate layer 550, and then laminated with the dimming film 560, the first glass body 510 and the second glass body 520 under the condition that the structural strength is satisfied after the imaging layer and the dimming film are attached to each other.

In some embodiments, the imaging layer can be one layer in the main structure of the dimming film to form a portion of the dimming film. As an example, when producing a dimming film, the imaging layer can be coated inside the PET substrate layer of the dimming film, so that the dimming film and the imaging layer are formed as a whole.

No matter what arrangement and combination mode, the vehicle window glass disclosed by the present disclosure can make the observer see a satisfied projection effect by combining the projection device with the back projection mode without affecting the structural performance and aesthetics of the vehicle window glass itself. It should be understood that although the PDLC film is described as a dimming film in the above-mentioned embodiments to improve the projection effect of display gain and provide the privacy protection function for the internal situation of the vehicle by its own haze function, other dimming films listed but not detailed can adopt similar structural combinations and achieve the same or similar above-mentioned effects.

For example, when the dimming film adjusts its light transmittance to darken (still remains transparent), the enhanced projection effect can be obtained by projecting to the inside or outside of the vehicle, such as the dimming film in the form of EC and GHLC. When the dimming film is adjusted to be hazed, the enhanced projection effect can be obtained by projecting to the inside or outside of the vehicle, and it has the function of protecting the privacy inside the vehicle, such as the dimming film in the form of PNLC. It should be understood that, under the condition that the performance of the dimming film allows, even the adjustment methods not illustrated in detail in this disclosure, such as the way that the dimming film adjusts the light transmittance to darken and adjusts the haze at the same time, it can also obtain the enhanced projection effect and the above-mentioned similar privacy protection function. Those skilled in the art can obtain various feasible solutions to meet different requirements based on the concept of the present disclosure, which are not enumerated exhaustively here.

It should be understood here that the embodiments shown in the drawings only illustrate the optional architectures, shapes, sizes and arrangements of various optional components of the vehicle window glass having the imaging layer and the dimming film in the vehicle-mounted projection system according to the present disclosure; however, it is only illustrative rather than restrictive, and other shapes, sizes and arrangements can be adopted without departing from the spirit and scope of the present disclosure.

The technical content and technical features of the present disclosure have been disclosed above. However, it can be understood that those skilled in the art can make various changes and improvements to the above disclosed concept under the creative idea of the present disclosure, all of which fall within the protection scope of the present disclosure. The description of the above embodiments is illustrative rather than restrictive, and the protection scope of the present disclosure is determined by the claims.

1. A vehicle window glass suitable for cooperating with a projection device to provide a projection function, wherein the vehicle window glass comprises a first glass body, a second glass body, and an imaging layer and a dimming film sandwiched between the first glass body and the second glass body, and wherein an image projected by the projection device on one side of the vehicle window glass displays the projected image on the other side via the vehicle window glass, and the dimming film is configured to be capable of adjusting light transmittance and/or haze to enhance the a projection effect of the imaging layer and/or provide privacy effect.

2. The vehicle window glass according to claim 1, wherein the vehicle window glass further comprises a first intermediate layer for attaching the dimming film to the first glass body, and the imaging layer is attached to the second glass body directly or through a second intermediate layer.

3. The vehicle window glass according to claim 2, wherein the imaging layer is directly attached to the second glass body by back adhesive or coating.

4. The vehicle window glass according to claim 2, wherein the imaging layer is directly attached to the dimming film or attached to the dimming film through a third intermediate layer.

5. The vehicle window glass according to claim 4, wherein the imaging layer is directly attached to the dimming film by coating.

6. The vehicle window glass according to claim 2, wherein the imaging layer is formed as a portion of the dimming film.

7. The vehicle window glass according to claim 2, wherein the imaging layer is formed as a portion of the second intermediate layer.

8. The vehicle window glass according to claim 7, wherein the imaging layer is formed as a portion of the second intermediate layer by being coated on or fused with the second intermediate layer.

9. The vehicle window glass according to claim 4, wherein the imaging layer is formed as a portion of the third intermediate layer.

10. The vehicle window glass according to claim 9, wherein the imaging layer is formed as a portion of the third intermediate layer by being coated on or fused with the third intermediate layer.

11. The vehicle window glass according to claim 1, wherein the imaging layer is configured as a back projection imaging layer of any one of film layer, coating layer and micro-structure layer.

12. The vehicle window glass according to claim 1, wherein the dimming film is configured as any one of polymer dispersed liquid crystal, polymer network liquid crystal, guest-host liquid crystal and electrochromic.

13. The vehicle window glass according to claim 1, wherein the dimming film is configured as polymer dispersed liquid crystal, and the imaging layer is closer to or farther from the projection device than the dimming film.

14. A vehicle-mounted projection system, wherein the vehicle-mounted projection system comprises a projection device, a human-machine interaction unit and a vehicle window glass according to claim 1.

15. The vehicle-mounted projection system according to claim 14, wherein the projection device is arranged inside or outside the vehicle so as to project image to outside or inside the vehicle.
